(19) United States
(12) Patent Application Publication
(10) Pub. No.: US 2011/0225961 A1
(43) Pub. Date: Sep. 22, 2011

(54) Pressurized Air-Spring Return Cylinder and Pneumatic Intensifier System

(75) Inventor: Michael O'Neal McCrary, Hampshire, TN (US)

(73) Assignee: Numatics, Incorporated, Novi, MI (US)

(21) Appl. No.: 13/130,626

(22) PCT Filed: Dec. 10, 2008
(86) PCT No.: PCT/US2008/086236

§ 371 Date: May 23, 2011

(51) Int. Cl. F15B 1/027; F15B 15/14; F15B 15/18

(52) U.S. Cl. 60/415; 91/165; 60/419

(57) ABSTRACT

A pneumatic cylinder system has a pneumatic supply at a first predetermined pneumatic pressure. A double acting cylinder is operably connected to the pneumatic supply and with a piston reciprocatingly mounted inside for retraction and extension of a piston arm connected to the piston. A high pressure pneumatic reserve chamber stores pneumatic reserve at a second predetermined pneumatic pressure that is higher than the first predetermined pressure. The high pressure pneumatic reserve chamber is operably connected to the double acting cylinder through a valve device such that when the pneumatic supply falls below a third predetermined pressure below the first predetermined pressure, the valve device opens communication between the high pressure pneumatic reserve chamber to a selected side of the double acting cylinder to selectively retract or extend the piston and the attached piston arm.

### TECHNICAL FIELD

The field of this invention relates to an air cylinder with a pressurized air-spring return cylinder.

### BACKGROUND OF THE DISCLOSURE

It is often desired that double acting cylinder and piston assemblies work off of a pressurized pneumatic supply to reciprocate the piston for retracting and extending the piston arm. It is often desired to provide a default position for the arm; i.e. the arm is in a normally extended or normally retracted position if the pneumatic pressure ceases or is otherwise shut off. This default retracted or extended position has been commonly accomplished with internal return springs that will mechanically retract or extend the piston arm. Coil springs for large bore air cylinders are fairly limited in availability, have limited range of bore sizes and are expensive. The working pneumatic pressure must also be increased to overcome the natural bias of the return coil spring. Furthermore, coil springs can rust and wear out.

As such, alternate ways to automatically return the piston arm to its default retracted or extended position have been developed. One method is to use a secondary reservoir air tank that has enough air supply to completely fill the air cylinder to either retract or extend the working piston and its attached piston arm. These tanks have an air supply stored at the same pneumatic pressure as the working pneumatic pressure of the primary air supply. Thusly, the tanks need to be at least three to four times as large as the double acting cylinder so that a sufficient pneumatic pressure is maintained to completely push the working piston to its retracted or extended end position within the cylinder. Consequently, these tanks are expensive due to their large size and weight.

What is needed is smaller return air spring tank that can house air at a second pneumatic pressure that is substantially above the pneumatic pressure of the working air supply. What is also needed is a pressure intensifier device that automatically fills the air tank to such a desired second pneumatic pressure. What is also desired is an air tank that is co-axially mounted with the working cylinder with a pressure intensifier mounted at a side thereof What is also needed is a pressure intensifier that runs off of a pneumatic supply at a first pneumatic pressure and has a pump section that can produce an increased pneumatic pressure output.

### SUMMARY OF THE DISCLOSURE

In accordance with one aspect of the invention, a pneumatic cylinder system has a pneumatic supply at a first predetermined pneumatic pressure. A double acting cylinder is operably connected to the pneumatic supply and has a piston operably mounted inside for reciprocating retraction and extension of a piston arm connected to the piston. A high pressure pneumatic reserve chamber stores pneumatic reserve at a second predetermined pneumatic pressure that is higher than the first predetermined pneumatic pressure. The high pressure pneumatic reserve chamber is operably connected to the double acting cylinder through a valve device such that when the pneumatic supply falls below a third predetermined pneumatic pressure below the first predetermined pneumatic pressure, the valve device opens communication between the high pressure pneumatic reserve chamber to a selected side of the double acting cylinder to selectively retract or extend the piston and the attached piston arm.

Preferably, the high pressure pneumatic reserve chamber is operably connected to a pressure intensifier assembly that pumps gas to the high pressure pneumatic reserve chamber at the second predetermined pneumatic pressure. It is desired that the pressure intensifier assembly includes a stepped cylinder and stepped piston with the pneumatic supply being operably connected to the larger diameter section of the stepped cylinder for controllably and reciprocally moving the stepped piston. The smaller diameter section of the cylinder functions as a pump for receiving gas therein and pumps it to the high pressure reserve chamber.

The pneumatic supply is preferably operably connected to one side of the smaller diameter section of the stepped cylinder for delivering pneumatic supply at the first predetermined pneumatic pressure therein during a fill stroke of the stepped piston. The high pressure pneumatic reserve chamber is operably connected to the smaller diameter piston of the stepped cylinder for receiving pneumatic supply at the second predetermined pressure therefrom during a pump stroke of the stepped piston.

In one embodiment, the high pressure pneumatic reserve chamber is co-axially mounted with the double acting cylinder and each are approximately the same diameter and length. The pressure intensifier assembly is mounted laterally on the side of the co-axially mounted high pressure pneumatic reserve chamber and the double acting cylinder.

In one embodiment, the piston arm is operably connected to a knife gate valve and the piston arm is extendable to its default position by pneumatic pressure flowing from the high pressure pneumatic reserve chamber to the double acting cylinder to close the knife gate valve.

According to another aspect of the invention, a pneumatic intensifier for supplying pneumatic pressure to a pneumatic pressure chamber has a stepped cylinder and a stepped piston slidably mounted in the stepped cylinder for reciprocating motion therein. A supply of pneumatic pressure at a first predetermined pressure is selectively and alternately in communication with each opposite side of a large diameter section of the stepped cylinder for reciprocally driving a large diameter section of the piston therein. The supply of pneumatic pressure is selectively in communication through a first port with one side of a smaller diameter section of the stepped cylinder for delivering the pneumatic supply at the first predetermined pneumatic pressure therein, when a smaller diameter section of the piston is retracting during a fill stroke with respect to the one side of the smaller diameter section. The one side of the smaller diameter section is also selectively openable through a second port to deliver pneumatic supply to the pneumatic reserve chamber during a pump stroke up to a second predetermined pneumatic pressure that is greater than the first predetermined pressure.

According to another aspect of the invention, a pneumatic driven pneumatic intensifier has a driving section connectable to a pneumatic supply at a first pneumatic pressure with a pneumatic supply running the driving section. A pump section has an inlet selectively for receiving a gas and an outlet selectively openable to deliver pneumatic supply at a second pneumatic pressure that is greater than the first pneumatic pressure. It is further desired that the pump section receives the gas from the pneumatic supply at the first predetermined pneumatic pressure.

### BRIEF DESCRIPTION OF THE DRAWINGS

Reference now is made to the accompanying drawings in which:

FIG. 1 is a perspective view of a knife gate valve incorporating an embodiment of a double acting cylinder and air tank and intensifier pump according to the invention;

FIG. 2 is a cross-sectional view of the intensifier pump shown in FIG. 1;

FIG. 3 is schematic view of the air flow through the double acting working cylinder, the air pump and the pressurized air spring return tank; and

FIG. 4 is a schematic enlarged view of an actuator and normally closed three way valve shown in FIGS. 2 and 3.

### DETAILED DESCRIPTION OF THE PREFERRED EMBODIMENT

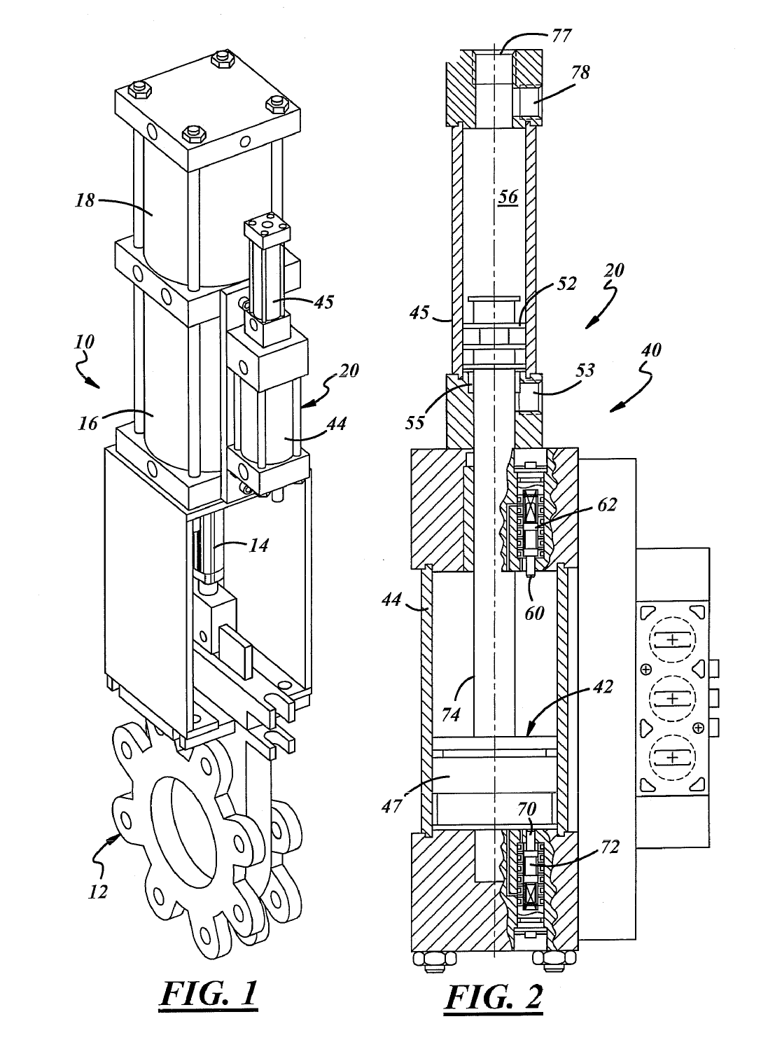

Referring now to FIG. 1, a double working cylinder and return air spring assembly 10 is operably connected to a knife gate valve 12. The knife gate valve 12 is shown in a closed position in FIG. 1. An end of a piston arm 14 extends from one end of the double working cylinder 16 for opening and closing the valve 12 and is attached to the knife gate valve 12. A return air spring tank 18 is coaxially mounted at an opposite end of the double acting cylinder 16. An air pump intensifier assembly 20 is mounted on the side of the double acting cylinder 16.

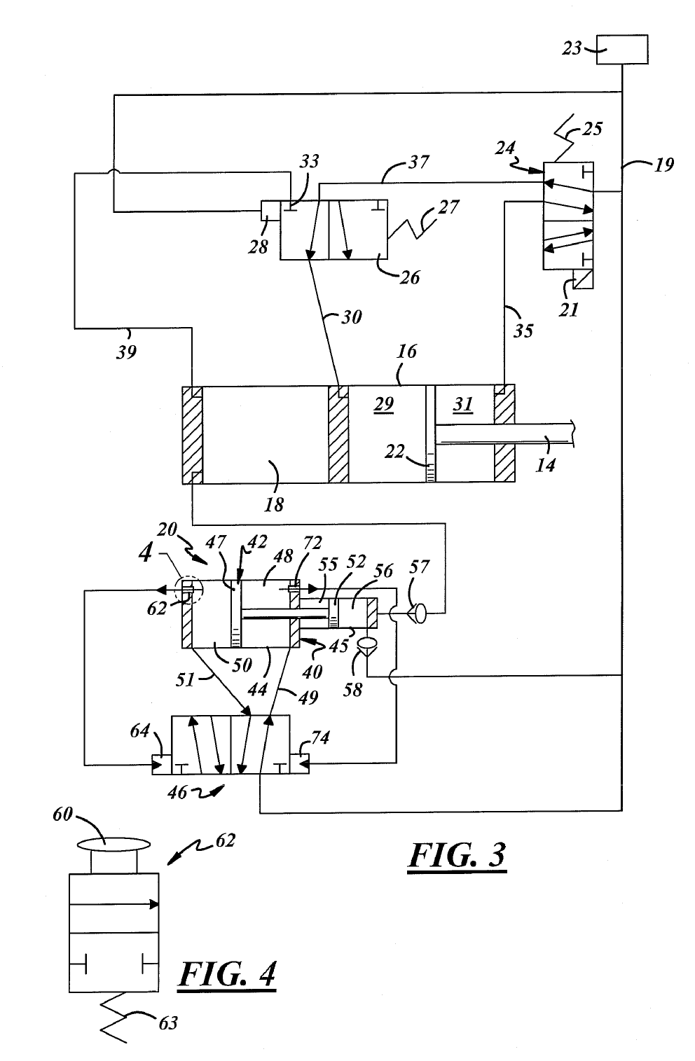

Referring now to FIG. 3, the double acting cylinder 16 has a working piston 22 slidably mounted for moving axially within the cylinder. The working cylinder 16 is operably connected to a working pneumatic pressure from air supply 23 that has line 19 in communication with a two position four way valve 24 that has a single actuation solenoid 21 and a return spring 25. When the control valve 24 is in a first shown position, air flows from air supply 23 through line 19 through control valve 24 and then through line 37 to a valve 26. The valve 26 has its position determined by a single air pilot 28 that biases the valve to the first position against bias of a return spring 27. The valve 26 is normally in the position shown in FIG. 3 when air pilot 28 is attached to air supply 23 that is at a normal working pneumatic pressure e.g. 60 p.s.i. When the valve 26 is in this normal position, pneumatic pressure from the control valve 24 flows therethrough and through line 30 to one side 29 of the cylinder to push the piston 22 to the right and extend the piston arm 14 to close the knife gate valve as shown in FIG. 1. Air from the other side 31 of the cylinder is exhausted though line 35 through the control valve 26.

When the control valve 24 is solenoid actuated, the valve 24 shifts to its other position to direct pneumatic pressure from air supply 23 directly to the other side 31 of the cylinder 16 to push piston 22 to the left and retract the piston arm 14 to open the knife gate valve 12. The air within cylinder section 29 is exhausted through line 30, back through valve 26, through line 37 and through valve 24.

Pressurized air is reserved in tank 18 and is blocked from exhausting via a line 39 through to a blind port 33 in valve 26. Thus, control of control valve 24 through it actuation solenoid 21 can controllably reciprocate the piston 22 within working cylinder 16.

When the air supply 23 decreases or completely depletes, due to power outage or other causes, the knife gate 12 automatically closes due to automatic extension of the piston arm 14. The air pilot 28 in valve 26 no longer acts against the spring return and thus the valve 26 moves to its second position to the left from the position shown in FIG. 3 which allows flow of pressurized air from tank 18 through line 39, through the valve 26, through line 30 and to the side 29 of cylinder to push the piston 22 to the right and extend the arm 14. Control valve 24 is spring biased to the first position when not actuated as shown in FIG. 3 and lets cylinder side 31 be exhausted through line 35. If the air supply 23 loses its pneumatic pressure for other reasons besides a power outage and control valve 24 is still actuated, the cylinder side 31 is still exhausted through control valve 24 and back into supply line 19 because of the low pneumatic pressure in line 19.

Air supply 23 normally provides a pneumatic pressure of about 60 p.s.i. to the double working cylinder. The tank 18 is pressurized to a pneumatic pressure of about 200 p.s.i. and is sized to have the same diameter and approximately the same length as double working cylinder 16 to provide sufficient pneumatic pressure and air supply to complete one full stroke to fully extend piston arm 14 and close knife gate valve 12.

Air tank 18 is pressurized to a level that is well above the working pneumatic pressure of the air supply 23 (60 p.s.i.) through the use of a piston intensifier assembly 20. The piston intensifier assembly 20 includes a stepped cylinder 40 having a stepped dual piston 42 inside. The larger diameter cylinder section 44 is connected to the air supply 23 through a two position four way valve 46. More particularly, during a return fill stroke of the piston 42 as shown in FIG. 3, the one side 48 of the large cylinder section 44 is connected to the air supply 23 through line 49 leading to the valve 46. Side 50 is exhausted through the valve 46 via line 51. During the fill stroke the smaller diameter section 45 of cylinder 40 has its side 56 filled through the check valve 58 from pressurized air supply 23. Side 55 is exhausted through an open port 53 in the cylinder housing as shown in FIG. 2. Check valve 57 is closed during this fill stroke to prevent air from escaping from tank 18.

As shown in FIG. 2, the stepped cylinder 40 has the normally non-actuated three way valves 62 and 72 housed at each end of large diameter section 44 where the large piston area 47 abuts the respective actuator 60 and 70 at each fill and pump stroke end. The large piston area 47 is connected to the small piston area 52 via a piston bar 75. Side 55 is in open communication with ambient port 53. Side 56 is in communication with ports 77 and 78 which can house check valves 57 and 58 respectively.

FIG. 4 illustrates in schematic fashion the actuator 60 and normally non-passing three way valve 62. The spring 63 normally biases the valve to close off line 19 to connected air supply 23 and exhausts air pilot 64 when actuator 60 is not pressed. When actuated, line 19 is open to air pilot 64. Valve 72 is similarly constructed to be normally biased to close off line 19 and exhaust air pilot 74. When valve 72 is actuated, line 19 is open to air pilot 74.

When the dual stepped piston 42 is fully returned and the fill stroke has ended, the piston 42 hits an actuator end 60 of the normally three way valve 62 to commence the pump stroke. The valve 62, when actuated, allows air from air supply 23 to pass through line 19 to the air pilot 64 of the valve 46 such that valve 46 shifts position to the right from the position shown in FIG. 3 to now let the air supply 23 be in communication with the side 50 of intensifier 20. Air lock behind air pilot 74 is prevented by air being exhausted through non-actuated valve 72. The pneumatic pressure exerted in cylinder side 50 pushes the larger piston area 47 to the right as shown in FIG. 3. Cylinder side 48 is exhausted through line 49 and through valve 46. During this pump stroke, smaller piston area 52 is pushed to the right and forces the air within side 56 of smaller cylinder section 44 to go through check valve 57 and to the tank 18. Check valve 58 is closed during this pump stroke. Ambient air is drawn in through open port 53 to side 55 to prevent vacuum lock behind piston area 52.

At the end of the pump stroke, the large piston area 48 engages an actuator end 70 of a normally closed three way valve 72 which similarly sends air to an air pilot 74 on the other side of valve 46 to shift it back to the left as shown in FIG. 3 to commence another fill stroke. Three way valve 62 is in the normal bias position that allows exhausting of air pilot 64 therethrough and prevents air lock. At the end of the full stroke, the cycle is repeated.

Because of the difference in diameter of the large piston area 48 compared to the small piston area 52, the air supply pressure 23 will continue to operate the intensifier 20 and pump air into the tank 18 until the pneumatic pressure within the tank 18 is well above the pneumatic pressure of the working air supply, in other words, the ratio of the two piston areas 48 and 52 will be approximately the ratio of the final pressure within tank 18 and the working pressure of air supply 23. While it is foreseen that a pressure ratio of three or four to one is foreseen, other pressure ratios can be easily accomplished merely by changing the ratio of working areas of pistons areas 48 and 52. The intensifier pump 20 will continue to work until an equilibrium is reached and it can no longer pump more air into tank.

While it is shown that the piston arm 14 will automatically extend upon cessation of air supply 23 to close knife gate 12, the high pressure tank 18 and working cylinder assembly 10 can be used with other applications and also can be used to automatically retract piston arm 14 upon the cessation of pneumatic pressure from air supply 23. A simple reversing of the two lines 30 and 35 to the double working cylinder 16 will cause the piston arm 14 to automatically retract as opposed to automatically extend during absence of air supply 23.

By having the tank 18 coaxially mounted with the working cylinder and being approximately the same size as the working cylinder, an easily manufactured assembly using duplicate parts is accomplished. Furthermore, the side mounting of the intensifier 20 onto the tank and cylinder assembly 12 provides for a compact package that can be easily mounted.

While the intensifier is described as being operating off of air supply 23, it is also foreseen that the intensifier 20 can be electrically driven. While air is the most common source for pneumatic pressure, other gases, e.g. nitrogen may be used for certain oxygen free application. While it is shown that the intensifier uses a reciprocating piston, other shaped pumps for example Wankel, spiral or rotary shaped pumps are also foreseen.

While not as efficient, it is also foreseen that the side 56 may draw in and receive ambient air from outside of cylinder section 45 rather than receive air from air supply 23.

Other variations and modifications are possible without departing from the scope and spirit of the present invention as defined by the appended claims.

1. A pneumatic cylinder system comprising:
a pneumatic supply at a first predetermined pneumatic pressure;
a double acting cylinder operably connected to said pneumatic supply and having a piston operably mounted inside for reciprocating retraction and extension of a piston arm connected to said piston;
a high pressure pneumatic reserve chamber for storing pneumatic reserve at a second predetermined pneumatic pressure that is higher than said first predetermined pneumatic pressure; and
said high pressure pneumatic reserve chamber operably connected to said double acting cylinder through a valve device such that when said pneumatic supply falls below a third predetermined pneumatic pressure below said first predetermined pneumatic pressure, said valve device opens communication between the high pressure pneumatic reserve chamber to a selected side of said double acting cylinder to selectively retract or extend said piston and the attached piston ann.

2. A pneumatic cylinder system as defined in claim 1 further comprising:
said high pressure pneumatic reserve chamber being operably connected to a pressure intensifier assembly that pumps to said high pressure pneumatic reserve chamber at said second predetermined pneumatic pressure.

3. A pneumatic cylinder system as defined in claim 2 further comprising:
said pressure intensifier assembly having a pump section with an inlet operably connected to said pneumatic supply at a first predetermined pressure to be filled by said pneumatic supply; and
said pressure intensifier assembly pumps said gas to said first predetermined pneumatic pressure to said high pressure pneumatic reserve chamber at said second predetermined pressure.

4. A pneumatic cylinder system as defined in claim 3 further comprising:
said pressure intensifier assembly comprising a stepped cylinder and stepped piston with said pneumatic supply operably connected to a larger diameter section of said stepped cylinder for controllably and reciprocally moving said piston;
the pneumatic supply being operably connected to one side of a smaller diameter section of said stepped cylinder for delivering pneumatic supply at said first pneumatic pressure therein; and
said high pressure pneumatic reserve chamber being operably connected to said smaller diameter section of said stepped cylinder for receiving pneumatic supply at said second predetermined pressure therefrom during a pump stroke of said piston.

5. A pneumatic cylinder system as defined in claim 4 further comprising:
said high pressure pneumatic reserve chamber being co-axially mounted with said double acting cylinder and each being approximately the same diameter and volume.

6. A pneumatic cylinder system as defined in claim 5 further comprising:
said pressure intensifier assembly being mounted laterally on the side of said co-axially mounted high pressure pneumatic reserve chamber and said double acting cylinder.

7. A pneumatic cylinder system as defined in claim 5 further comprising:
said piston arm being operably connected to a knife gate valve; and
said high pressured pneumatic reserve chamber connected to said double acting cylinder to extend said piston arm by pneumatic pressure and to close a knife gate valve.

8. A pneumatic cylinder system as defined in claim 2 further comprising:
said pressure intensifier assembly comprising a stepped cylinder and stepped piston with said pneumatic supply operably connected to a larger diameter section of said stepped cylinder for controllably and reciprocally moving said piston; and
a smaller diameter section of said stepped cylinder functioning as a pump for receiving gas therein during a fill stroke of said piston and pumping said gas to said high pressure pneumatic reserve chamber at said second predetermined pressure therefrom during a pump stroke of said piston.

9. A pneumatic intensifier for supplying pneumatic pressure to a pneumatic pressure chamber, said pneumatic intensifier comprising:
a stepped cylinder;
a stepped piston slidably mounted in said stepped cylinder for reciprocating motion therein;
a supply of pneumatic pressure at a first predetermined pressure selectively and alternately in communication with each opposite side of a larger diameter section of said stepped cylinder for reciprocally driving a larger diameter section of said piston therein;
said supply of pneumatic pressure being selectively in communication through a first port with one side of a smaller diameter section of said stepped cylinder for delivering said pneumatic supply at said first predetermined pressure therein, when a smaller diameter section of said piston is retracting with respect to said one side of the smaller diameter section; and
said one side of said smaller diameter section of said stepped cylinder being selectively openable through a second port to deliver pneumatic supply to said pneumatic reserve chamber at a second predetermined pneumatic pressure that is greater than said first predetermined pneumatic pressure.

10. A pneumatic driven pneumatic intensifier comprising:
a driving section connectable to a pneumatic supply at a first pneumatic pressure with said pneumatic supply running said driving section; and
a pump section having an inlet for receiving a gas and an outlet selectively openable to deliver said gas at a second pneumatic pressure that is greater than said first pneumatic pressure.

11. A pneumatic driven pneumatic intensifier as defined in claim 10 further comprising:
said pump section receiving gas from said pneumatic supply at said first pneumatic pressure.
